(19) United States
(12) Patent Application Publication
(10) Pub. No.: US 2022/0359923 A1
(43) Pub. Date: Nov. 10, 2022

(54) Battery Module

(71) Applicants: Hyundai Motor Company, Seoul (KR); Kia Corporation, Seoul (KR)

(72) Inventors: Hae Kyu Lim, Bucheon-si (KR); Ji Woong Jung, Anyang-si (KR); Tae Hyuck Kim, Asan-si (KR); Yu Ri Oh, Hwaseong-si (KR); Ju Hyeok Park, Incheon (KR); Woo Chan Lee, Hwaseong-si (KR); Woo Young Choi, Anyang-si (KR); Gyung Hoon Shin, Seoul (KR)

(21) Appl. No.: 17/871,138

(22) Filed: Jul. 22, 2022

Related U.S. Application Data
(63) Continuation-in-part of application No. 17/388,834, filed on Jul. 29, 2021.

(30) Foreign Application Priority Data
Sep. 15, 2020 (KR) 10-2020-0118578
Sep. 13, 2021 (KR) 10-2021-0121831

(51) Int. Cl. H01M 10/48; H01M 50/204; H01M 50/289; H01M 10/613; H01M 10/658; H01M 10/6556

(52) U.S. Cl. CPC H01M 10/486; H01M 50/204; H01M 50/289; H01M 10/482; H01M 10/613; H01M 10/658; H01M 10/6556

(57) ABSTRACT

An embodiment battery module includes a plurality of battery cells, a cooling channel disposed below the plurality of battery cells, a heat transfer material disposed between the plurality of battery cells and the cooling channel, end plates covering outer surfaces of outermost battery cells of the plurality of battery cells, wherein an installation space is provided at a lower end of each of the end plates, temperature sensors disposed in the installation spaces at the lower ends of the respective end plates, wherein the temperature sensors are configured to measure temperatures of the plurality of battery cells, and sensor covers combined with outer surfaces of the end plates at points respectively provided with the temperature sensors installed therein, wherein the sensor covers include a lower end bent to cover a lower surface of a corresponding one of the temperature sensors.

### CROSS-REFERENCE TO RELATED APPLICATIONS

This application is a continuation-in-part of U.S. patent application Ser. No. 17/388,834, filed on Jul. 29, 2021, and claims the benefit of Korean Patent Application No. 10-2021-0121831, filed on Sep. 13, 2021, and Korean Patent Application No. 10-2020-0118578, filed on Sep. 15, 2020, which applications are hereby incorporated herein by reference.

### TECHNICAL FIELD

The present invention relates to a battery module.

### BACKGROUND

Recently, in order to follow the global trend of reduction in carbon dioxide emissions, instead of typical internal combustion engine vehicles which generate driving power through combustion of fossil fuels, demand for electric vehicles which generate driving power due to driving of a motor using electric energy stored in an energy storage device, such as a battery, is rapidly increasing.

The performance of an electric vehicle greatly depends on the capacity and performance of a battery corresponding to an energy storage device configured to store electric energy to be supplied to a motor. The battery for vehicles configured to store electric energy to be supplied to the motor so as to generate the driving power of the vehicle needs to have excellent electrical characteristics, such as excellent charging and discharging performance, a long service life, etc., and needs to secure high mechanical performance so as to withstand severe driving environments of the vehicle, such as high temperature, high vibration, etc. Further, in view of vehicle manufacturers, it is advantageous to configure battery hardware in the form of a module having a standardized size or capacity so as to be universally applied to various kinds of vehicles.

A conventional battery cooling system forms a cooling channel structure configured to cool the lower ends of battery cells using an indirect water cooling method. Further, in order to press the cooling channel and the battery cells against each other, a heat transfer material is applied as a gap filler between the cooling channel and the battery cells. Here, when a temperature sensor configured to measure the temperature of the battery cells comes into contact with the gap filler (the heat transfer material), the temperature sensor may measure the temperature of a battery case, the cooling channel or the heat transfer material other than the temperatures of the battery cells, or may be influenced by the battery case, the cooling channel or the heat transfer material, and thereby, accuracy in temperature measurement is reduced.

The lifespan and the performance of the battery are greatly influenced by temperature, and it is important to maintain the temperature of the battery within a designated range under any conditions and thus to secure the optimum performance of the battery. Therefore, it is very important to secure accuracy in temperature measurement.

The above information disclosed in the background section is only for enhancement of understanding of the background of the invention and should not be interpreted as conventional technology that is already known to those skilled in the art.

### SUMMARY

The present invention relates to a battery module. Particular embodiments relate to a battery module that may enable temperature sensors to be spaced apart from a heat transfer material or a cooling channel for cooling battery cells in a structure in which the temperature sensors are applied to the battery module, may reduce thermal influence therebetween, and may allow the temperature sensors to remove external environmental factors in measurement of the overall temperature of the battery cells so as to minimize a negative influence of the environmental factors on measurement of the temperature of the battery cells.

Therefore, embodiments of the present invention can solve problems in the art, and embodiments of the present invention provide a battery module which may enable temperature sensors to be spaced apart from a heat transfer material or a cooling channel for cooling battery cells in a structure in which the temperature sensors are applied to the battery module, may reduce thermal influence therebetween, and may allow the temperature sensors to remove external environmental factors in measurement of the overall temperature of the battery cells so as to minimize a negative influence of the environmental factors on measurement of the temperature of the battery cells.

In accordance with embodiments of the present invention, the above and other features can be accomplished by the provision of a battery module configured such that a cooling channel is disposed below battery cells and a heat transfer material is provided between the battery cells and the cooling channel, the battery module including end plates configured to cover outer surfaces of outermost battery cells and provided with an installation space formed at the lower end of each of the end plates, temperature sensors installed in the installation spaces at the lower ends of the respective end plates and configured to measure temperatures of the battery cells, and sensor covers combined with outer surfaces of the end plates at points respectively provided with the temperature sensors installed therein, and configured to have a lower end bent to cover the lower surface of a corresponding one of the temperature sensors so as to prevent thermal interference due to the cooling channel or the heat transfer material.

Each of the installation spaces may be prepared by forming an installation hole configured to receive a corresponding one of the temperature sensors in the lower end of each of the end plates, and each of the temperature sensors may be located in the installation space so as to be pressed against the lower end of the side surface of a corresponding one of the outermost battery cells opposite the temperature sensors.

Each of the temperature sensors may be covered with the lower end of a corresponding one of the sensor covers, and may thus be spaced apart from the cooling channel or the heat transfer material so as to prevent thermal interference due to the cooling channel or the heat transfer material.

The sensor covers may be formed of a polymer or nonwoven fabric that is a thermal insulation material.

The sensor covers may be formed of a thermal insulation material so as to prevent indirect thermal interference with the temperature sensors due to the cooling channel or the heat transfer material.

The battery module may further include a lower plate combined with lower ends of the battery cells through the heat transfer material and configured to form an upper end of the cooling channel.

Each of the end plates may include an inner plate configured to come into contact with the outer surface of a corresponding one of the outermost battery cells, and an outer plate configured to cover an outer surface of the inner plate.

The inner plate may be formed by molding using an insulation material so as to insulate the battery cells from an outside, and the outer plate may be formed by molding using a metal so as to reinforce rigidity.

Each of the installation spaces configured such that a corresponding one of the temperature sensors is installed therein may be prepared by forming an installation hole in the lower end of the inner plate.

Each of the installation spaces may be formed in the inner plate, and the outer plate covers an outer surface of the temperature sensor installed in the inner plate.

Each of the sensor covers may cover an outer surface of a portion of the outer plate provided with a corresponding one of the temperature sensors installed therein so as to prevent thermal interference with the temperature sensor due to external environments.

Each of the sensor covers may be adhered to the outer plate, and may be provided with the lower end bent to be adhered to the lower end of a corresponding one of the temperature sensors.

### BRIEF DESCRIPTION OF THE DRAWINGS

The above and other objects, features and other advantages of embodiments of the present invention will be more clearly understood from the following detailed description taken in conjunction with the accompanying drawings, in which:

FIG. 1 is a view illustrating a battery module according to one embodiment of the present invention;

FIG. 2 is an enlarged view of a portion K shown in FIG. 1;

FIG. 3 is a front view illustrating the battery module according to one embodiment of the present invention in a state in which a temperature sensor and a sensor cover are combined with each other; and

FIG. 4 is a view illustrating an inner plate of the battery module according to one embodiment of the present invention.

### DETAILED DESCRIPTION OF ILLUSTRATIVE EMBODIMENTS

Specific structural or functional descriptions in embodiments of the present invention set forth in the description which follows will be exemplarily given to describe the embodiments of the present invention, but the present invention may be embodied in many alternative forms, and should not be construed as being limited to the embodiments set forth herein. Hereinafter, reference will be made in detail to the embodiments of the present invention, examples of which are illustrated in the accompanying drawings.

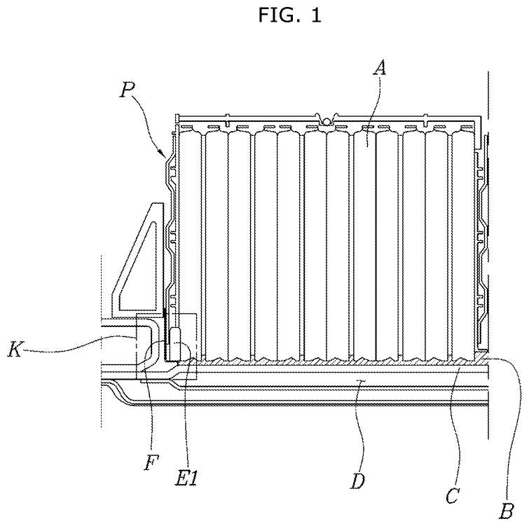

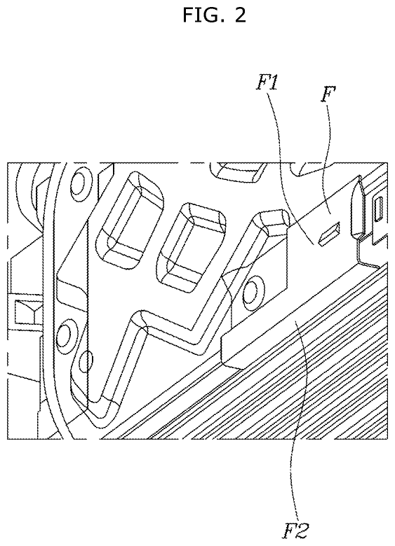

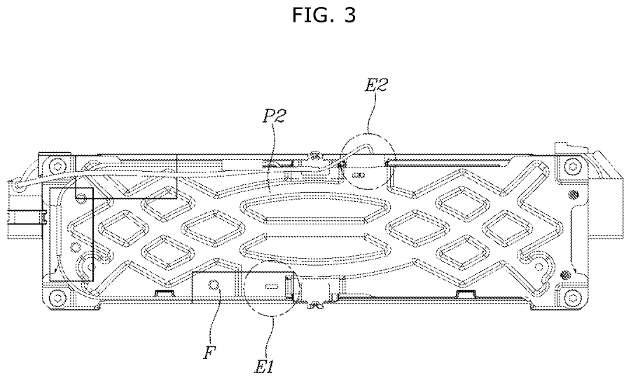

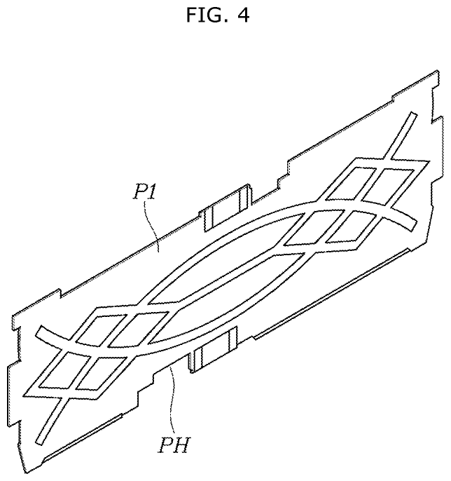

FIG. 1 is a view illustrating a battery module according to one embodiment of the present invention, FIG. 2 is an enlarged view of a portion K shown in FIG. 1, FIG. 3 is a front view illustrating the battery module according to one embodiment of the present invention in a state in which a temperature sensor and a sensor cover are combined with each other, and FIG. 4 is a view illustrating an inner plate of the battery module according to one embodiment of the present invention.

FIG. 1 is a view illustrating the battery module according to one embodiment of the present invention.

Referring to FIG. 1, the battery module according to one embodiment of the present invention is configured such that a cooling channel D is disposed below battery cells A and a heat transfer material B is provided between the battery cells A and the cooling channel D. The battery module further includes end plates P configured to cover the outer surfaces of the outermost battery cells A and provided with an installation space formed at the lower end of each of the end plates P, temperature sensors E installed in the installation spaces at the lower ends of the respective end plates P and configured to measure the temperatures of the battery cells A, and sensor covers F combined with the outer surfaces of the end plates P at points provided with the temperature sensors E installed therein and configured to have the lower end bent to cover the lower surface of a corresponding one of the temperature sensors E so as to prevent thermal interference due to the cooling channel D or the heat transfer material B.

Embodiments of the present invention may optimize the lifespan and the performance of a battery by accurately measuring the temperature of the battery. In the battery, a plurality of battery cells forms a battery module, and a plurality of battery modules forms a battery pack. Here, in order to accurately measure the temperatures of the battery cells of each battery module, the temperature of the battery is predicted by measuring the temperatures of the upper and lower portions of the battery cells and integrating the measured temperatures.

In order to measure the upper portions of the battery cells, upper temperature sensors E2 configured to measure the temperature of the central region of the upper portion of the stack of the battery cells are installed, as shown in FIG. 3. Further, in order to measure the temperatures of the lower portions of the battery cells, lower temperature sensors E1 configured to come into contact with both outermost battery cells are provided. Thereby, the overall temperature distribution of the battery may be detected by measuring the temperatures of the upper and lower portions of the battery, and particularly, the lower temperature sensors E1 may be disposed at the outer regions of the battery so as to detect an external environmental influence.

Here, the lower temperature sensors E1 are installed at the lower portions of the outermost battery cells A due to various reasons, and the reason for this is that the end plates P are combined with the side surfaces of the outermost battery cells A, and thus, it is difficult to install the lower temperature sensors E1 at the centers of the outer surfaces of the battery cells A and it is difficult to prepare installation spaces at the centers of the outer surfaces of the battery cells A due to support structures, such as members, combined therewith.

Therefore, each of the lower temperature sensors E1 is provided at the lower portion of the outer surface of a corresponding one of the outermost battery cells A so as to secure the installation space for the lower temperature sensor E1 and to minimize overlapping or interference with other external support structures, thereby being stably installed.

However, in this case, the lower temperature sensors E1 are adjacent to the cooling channel D disposed below the battery cells A, and thus, values measured by the lower temperature sensors E1 may be inaccurate due to the influence of the cooling channel D, a battery case or external environments. Embodiments of the present invention may address the above problem, and it is an embodiment of the present invention to secure accuracy in temperature measurement using the lower temperature sensors E1 while securing the installation positions of the lower temperature sensors E1.

For this purpose, in embodiments of the present invention, the battery module is configured such that the heat transfer material B and the temperature sensors E are spaced apart from or isolated from each other, and thermal interference with the temperature sensors E due to the cooling channel D or the heat transfer material B is prevented by covering the lower surfaces of the temperature sensors E with separate covers.

The indirect water cooling method is generally used to measure the temperature of the battery, and a structure in which the lower ends of the battery cells are cooled through a separate cooling channel or the like is formed. Here, when the temperature sensors E configured to measure the temperatures of the battery cells come into contact with a gap filler (the heat transfer material), the temperature sensors may inaccurately measure the temperatures of the battery cells due to the influence of the temperature of a battery case or the temperature of the cooling channel. The lifespan and the performance of the battery are greatly influenced by temperature, and it is important to secure the optimum performance of the battery by accurately measuring the temperatures of the battery cells and thereby maintaining the temperature of the battery within a designated range under any conditions.

More concretely, the end plates P are configured to cover the outer surfaces of the outermost battery cells A, and each of the end plates P is provided with the installation space for the temperature sensors E formed at the lower end thereof. A plurality of battery cells A is stacked in the horizontal direction, and the end plates P are disposed at both ends of the stack of the battery cells A so as to fix the outermost battery cells A.

As shown in FIGS. 1, 3 and 4, the end plate P includes an inner plate P1 configured to come into contact with the outer surface of a corresponding one of the outermost battery cells A and an outer plate P2 configured to cover the outer surface of the inner plate P1, so as to have a dual protective structure. In general, the inner plate P1 is formed of an insulating material, such as plastic, and the outer plate P2 is formed of steel so as to reinforce rigidity of a battery cover.

The cooling channel D disposed below the battery cells A may be provided as a cooling flow path in which a coolant flows, and the upper end of the cooling channel D may be formed by a lower plate C combined with the lower ends of the battery cells A through the heat transfer material B. The coolant flows in the cooling channel D, thereby indirectly cooling or heating the battery cells A disposed above the cooling channel D.

The heat transfer material B referred to as the gap filler is applied to the lower plate C configured to form the upper surface of the cooling channel D, and the battery cells A are disposed after the heat transfer material B is applied to the lower plate C. In order to prevent overflow of the gap filler or to prevent overcooling of the battery cells A due to spreading of the gap filler due to pressure applied by the battery cells A disposed on the gap filler when an excessively large amount of the gap filler is applied, it is necessary to adjust the amount of the gap filler. It is difficult to press the cooling channel D and the lower ends of the battery cells A against each other, and thus, a gap therebetween is filled with the heat transfer material B, thereby being capable of maximally securing the contact area between the battery cells A and the cooling channel D and thus increasing heat transfer efficiency.

The lower temperature sensors E1 are installed in the installation spaces of the lower ends of the respective end plates P, and measure the temperatures of the battery cells A. The temperature sensors E may be disposed at the central region of the stack of the battery cells A and at the lower ends of the outermost battery cells A, the temperature of the battery may be accurately acquired by analyzing a temperature difference between the temperatures of the battery cells A sensed by the lower temperature sensors E1 disposed at the lower ends of the outermost battery cells A and the temperatures of the battery cells S sensed by the upper temperature sensors E2 disposed at the central region of the stack of the battery cells A, and thereby, the lifespan and the performance of the battery may be optimized. As described above, the lower temperature sensors E1 are installed at the lower ends of the outermost battery cells S so as to prevent interference with other elements, to secure the installation positions of the lower temperature sensors E1, and to facilitate assembly of the battery module.

The sensor covers F are combined with the outer surfaces of the end plates P at points provided with the temperature sensors E installed therein, and are configured to have the lower end bent to cover the lower surface of a corresponding one of the temperature sensors E so as to prevent thermal interference due to the cooling channel D or the heat transfer material B. The sensor covers F may be formed of nonwoven fabric so as to be easily adhered to the outer plates P2, may be easily bent so as to be maximally pressed against the outer plates P2, and may have thermal insulation performance. The sensor covers F may be formed of the nonwoven fabric so as to secure thermal insulation performance, thereby minimizing thermal influence of external environments on the temperature sensors E.

More particularly, the installation space is prepared by forming an installation hole PH configured to receive the inner plate P1 in the lower end of the inner plate P, and the lower temperature sensor E1 is located in the installation space so as to be pressed against the lower end of the side surface of a corresponding one of the outermost battery cells A opposite the lower temperature sensor E1.

The inner plate P1 and the lower temperature sensor E1 are combined with each other by locating the lower temperature sensor E1 in the installation space formed at the lower end of the inner plate P1. Among the temperature sensors E, the lower temperature sensors E1 are located in the installation spaces and are pressed against the lower ends of the side surfaces of the outermost battery cells A, and the temperature of the battery may be accurately acquired by analyzing the temperatures measured by the lower temperature sensors E1 disposed at the lower ends of the outermost battery cells A and the temperatures measured by the upper temperature sensors E2 disposed at the central region of the stack of the battery cells A. More concretely, the lower temperature sensors E1 are pressed against the lower ends of the side surfaces of the outermost battery cells A, and thus measure the temperatures of the battery cells A.

Further, the lower end of the lower temperature sensor E1 is covered with a bent part F2 of the sensor cover F, and may thus be spaced apart from the cooling channel D and the heat transfer material B so as to prevent thermal interference due to the cooling channel D or the heat transfer material B.

The lower temperature sensors E1 may be influenced by the coolant flowing in the cooling channel D, and may be influenced by the heat transfer material B when the lower temperature sensors E come into contact with the heat transfer material B by the lower plate C. Thermal interference of the coolant flowing in the cooling channel D with the lower temperature sensor E1 is decreased as the distance between the temperature sensor E1 and the cooling channel D and the heat transfer material B is increased, and is decreased when the temperature sensor E1 avoids contact with the heat transfer material B by the lower plate C. Therefore, when the lower temperature sensors E1 are spaced apart from the cooling channel D and the heat transfer material B or isolated from the cooling channel D and the heat transfer material B by a thermal insulation material, thermal interference due to the cooling channel D and the heat transfer material B is prevented, and thus, the temperature of the battery may be accurately acquired and noise caused by the temperatures of elements around the battery cells A and outdoor air temperature may be removed.

FIG. 3 is a view illustrating the lower temperature sensor E1 and the sensor cover F of the battery module according to one embodiment of the present invention.

The sensor cover F may be formed of a polymer or nonwoven fabric which is a thermal insulation material. Further, the sensor cover F formed of the thermal insulation material may prevent indirect thermal interference with the lower temperature sensor E1 due to the cooling channel D or the heat transfer material E, and may prevent heat transference with the lower temperature sensor E1 due to external environments.

Thermal insulation indicates the reduction of heat transfer between objects, and thermal insulation performance is required to prevent thermal interference with the battery cells A due to the cooling channel D or the heat transfer material B. The sensor covers F formed of a polymer or nonwoven fabric, which is a thermal insulation material, have thermal insulation performance, and may thus prevent thermal interference with the battery cells A due to the cooling channel D or the heat transfer material B. Therefore, the sensor cover F formed of a polymer or nonwoven fabric, which is a thermal insulation material, includes a main part F1 adhered to the outer plate P1 of the end plate P so as to prevent indirect thermal interference with the lower temperature sensor E1 due to external environments, and the bent part F2 configured to be bent from the lower end of the main part F1 and adhered to the lower part of the lower temperature sensor E1 so as to prevent influence of the cooling channel D or the like.

The lower plate C is combined with the lower ends of the battery cells A through the heat transfer material B, and forms the upper end of the cooling channel D.

Here, the heat transfer material B referred to as the gap filler is applied to the lower plate C, and the battery cells A are disposed after the heat transfer material B is applied to the lower plate C. The upper end of the cooling channel D is referred to as the lower plate C, and the sensor cover F reduces thermal interference with the lower temperature sensor E1 through the lower plate C.

The end plate P includes the inner plate P1 configured to come into contact with the outer surface of the outermost battery cell A and an outer plate P2 configured to cover the outer surface of the inner plate P1. Further, the inner plate P1 may be formed by molding using an insulating material so as to thermally insulate the battery cells A from the outside, as shown in FIG. 4, and the outer plate P2 may be combined with the outer surface of the inner plate P1 and be formed by molding using a metal so as to reinforce rigidity, as shown in FIGS. 1 and 3.

In general, the inner plate P1 is formed of an insulating material, such as plastic, and the outer plate P2 is formed of steel so as to reinforce rigidity of the battery cover. Thermal insulation means that signals or power is transmitted between separated elements, and, in embodiments of the present invention, the battery cells A must transmit signals or power to a desired element while blocking unnecessary transfer when the battery is used, and thus, the end plates P have a dual structure including the inner plate P1 and the outer plate P2 so as to achieve such thermal insulation. Therefore, the end plate P includes the inner plate P1 configured to come into contact with the outer surface of the outermost battery cell A and the outer plate P2 configured to cover the outer surface of the inner plate P1. The end plates P having such a dual structure may effectively protect the battery cells A, and may secure a thermal insulation function and rigidity of the battery case.

Particularly, the installation space in which the lower temperature sensor E1 is installed may be prepared by forming the installation hole PH in the lower end of the inner plate P1, as shown in FIG. 4.

The inner plate P1 comes into contact with the outer surface of the outermost battery cell A, and needs to be located close to the battery cells A in order to enable the lower temperature sensor E1 to measure the inner and outer temperatures of the outermost battery cell A. The lower temperature sensor E1 configured to measure the inner and outer temperatures of the outermost battery cell A is disposed at the lower end of the inner plate P1 through the installation hole PH, and the lower temperature sensor E1 may be located in the installation hole PH so as to be pressed against the outermost battery cell A, and may be disposed at the lower end of the inner plate P1 so that the temperatures measured by the respective lower temperature sensors E1 and the temperatures measured by the respective upper temperature sensors E2 disposed at the central region of the stack of the battery cells A may be analyzed, thereby being capable of achieving accurate measurement of the temperature of the battery and optimizing the lifespan and the performance of the battery.

The installation space is formed in the inner plate P1, and the outer plate P2 may cover the entirety of the inner plate P1 while covering the outer surface of the lower temperature sensor E1 installed in the inner plate P1. Further, the sensor cover F may cover the outer surface of the portion of the outer plate P2, at which the lower temperature sensor E1 is installed, thereby being capable of preventing thermal interference with the temperature sensor E due to external environments.

The lower temperature sensor E1 is located in the installation space formed in the inner plate P1. The end plate P has the dual structure including the inner plate P1 and the outer plate P2 configured to cover the outer surface of the inner plate P1, the lower temperature sensor E1 may be located as close to the battery cells as possible so as to measure the temperature of the outermost battery cell A, and the outer plate P2 may cover the outer surface of the lower temperature sensor E1 so as to protect the battery cells A. When the outer surface of the lower temperature sensor E1 is covered, the lower temperature sensor E1 may be protected, and thermal interference of an excessively low or high external temperature with the lower temperature sensor E1 may be prevented, thereby being capable of more accurately measuring the temperature of the battery.

The sensor cover F may be adhered to the outer plate P2, and the lower end of the sensor cover F may be bent to be adhered to the lower end of the lower temperature sensor E1.

The end plate P may include the inner plate P1 configured to come into contact with the outer surface of the outermost battery cell A and the outer plate P2 configured to cover the outer surface of the inner plate P1, and the sensor cover F formed of a polymer or nonwoven fabric, which is a thermal insulation material, may be adhered to the outer plate P2 formed of steel to reinforce rigidity so as to cover the side surface and the lower end of the temperature sensor E2. The lower end of the sensor cover F may be bent to be adhered to the lower end of the lower temperature sensor E1 so as to fix the lower temperature sensor E1, and the side end of the sensor cover F may cover the outer surface of the portion of the outer plate P2, at which the lower temperature sensor E1 is installed, and thereby, the sensor cover F serves to prevent thermal interference of external environments with the lower temperature sensor E1.

The above-described battery module according to embodiments of the present invention may enable the temperature sensors to be spaced apart from the heat transfer material or the cooling channel for cooling the battery cells in a structure in which the temperature sensors are applied to the battery module, may reduce thermal influence therebetween, and may allow the temperature sensors to remove external environmental factors in measurement of the overall temperature of the battery cells so as to minimize a negative influence of the environmental factors on measurement of the temperature of the battery cells.

As is apparent from the above description, a battery module according to embodiments of the present invention may enable temperature sensors to be spaced apart from a heat transfer material or a cooling channel for cooling battery cells in a structure in which the temperature sensors are applied to the battery module, may reduce thermal influence therebetween, and may allow the temperature sensors to remove external environmental factors in measurement of the overall temperature of the battery cells so as to minimize a negative influence of the environmental factors on measurement of the temperature of the battery cells.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A battery module comprising:
a plurality of battery cells;
a cooling channel disposed below the plurality of battery cells;
a heat transfer material disposed between the plurality of battery cells and the cooling channel;
end plates covering outer surfaces of outermost battery cells of the plurality of battery cells, wherein an installation space is provided at a lower end of each of the end plates;
temperature sensors disposed in the installation spaces at the lower ends of the respective end plates, wherein the temperature sensors are configured to measure temperatures of the plurality of battery cells; and
sensor covers combined with outer surfaces of the end plates at points respectively provided with the temperature sensors installed therein, wherein the sensor covers include a lower end bent to cover a lower surface of a corresponding one of the temperature sensors.

2. The battery module according to claim 1, wherein the sensor covers are configured to prevent thermal interference due to the cooling channel or the heat transfer material.

3. The battery module according to claim 1, wherein:
each of the installation spaces comprises an installation hole configured to receive a corresponding one of the temperature sensors in the lower end of each of the end plates; and
each of the temperature sensors is located in the installation space and pressed against a lower end of a side surface of a corresponding one of the outermost battery cells opposite the temperature sensors.

4. The battery module according to claim 1, wherein each of the temperature sensors is covered with a lower end of a corresponding one of the sensor covers and is spaced apart from the cooling channel or the heat transfer material.

5. The battery module according to claim 1, wherein the sensor covers comprise a polymer or nonwoven fabric that is a thermal insulation material.

6. The battery module according to claim 1, wherein the sensor covers comprise a thermal insulation material configured to prevent indirect thermal interference with the temperature sensors due to the cooling channel or the heat transfer material.

7. The battery module according to claim 1, further comprising a lower plate combined with lower ends of the plurality of battery cells through the heat transfer material, wherein the lower plate is configured to define an upper end of the cooling channel.

8. A battery module comprising:
a plurality of battery cells;
a cooling channel disposed below the plurality of battery cells;
a heat transfer material disposed between the plurality of battery cells and the cooling channel;
end plates covering outer surfaces of outermost battery cells of the plurality of battery cells, wherein an installation space is provided at a lower end of each of the end plates, wherein each of the end plates comprises:
an inner plate configured to come into contact with the outer surface of a corresponding one of the outermost battery cells; and
an outer plate configured to cover an outer surface of the inner plate.
temperature sensors disposed in the installation spaces at the lower ends of the respective end plates, wherein the temperature sensors are configured to measure temperatures of the plurality of battery cells; and
sensor covers combined with outer surfaces of the end plates at points respectively provided with the temperature sensors installed therein, wherein the sensor covers include a lower end bent to cover a lower surface of a corresponding one of the temperature sensors.

9. The battery module according to claim 8, wherein the inner plate comprises a molded insulation material configured to insulate the plurality of battery cells from an outside, and the outer plate comprised a molded metal configured to reinforce rigidity.

10. The battery module according to claim 9, wherein an installation hole is provided in a lower end of the inner plate, and wherein one of the temperature sensors is provided in a corresponding one of the installation spaces through the installation hole.

11. The battery module according to claim 10, wherein each of the installation spaces is provided in the inner plate, and wherein the outer plate covers an outer surface of the temperature sensor provided in the inner plate.

12. The battery module according to claim 11, wherein each of the sensor covers covers an outer surface of a portion of the outer plate provided with a corresponding one of the temperature sensors installed therein.

13. The battery module according to claim 12, wherein the sensor covers are configured to prevent thermal interference with the temperature sensor due to external environments.

14. The battery module according to claim 11, wherein each of the sensor covers is adhered to the outer plate and is provided with the lower end bent to be adhered to a lower end of a corresponding one of the temperature sensors.

15. The battery module according to claim 8, wherein the sensor covers are configured to prevent thermal interference due to the cooling channel or the heat transfer material.

16. The battery module according to claim 8, wherein:
each of the installation spaces comprises an installation hole configured to receive a corresponding one of the temperature sensors in the lower end of each of the end plates; and
each of the temperature sensors is located in the installation space and pressed against a lower end of a side surface of a corresponding one of the outermost battery cells opposite the temperature sensors.

17. The battery module according to claim 8, wherein each of the temperature sensors is covered with a lower end of a corresponding one of the sensor covers and is spaced apart from the cooling channel or the heat transfer material.

18. The battery module according to claim 8, wherein the sensor covers comprise a polymer or nonwoven fabric that is a thermal insulation material.

19. The battery module according to claim 8, wherein the sensor covers comprise a thermal insulation material configured to prevent indirect thermal interference with the temperature sensors due to the cooling channel or the heat transfer material.

20. The battery module according to claim 8, further comprising a lower plate combined with lower ends of the plurality of battery cells through the heat transfer material, wherein the lower plate is configured to define an upper end of the cooling channel.
